(19) United States
(12) Patent Application Publication
(10) Pub. No.: US 2025/0094774 A1
(43) Pub. Date: Mar. 20, 2025

(54) IMPLEMENTING DIALOG-BASED MUSIC RECOMMENDATIONS FOR VIDEOS

(71) Applicant: Lemon Inc., Grand Cayman (KY)

(72) Inventors: Peng Zhang, Los Angeles, CA (US); Zhikang Dong, Culver City, CA (US); Bin Chen, Los Angeles, CA (US); Xiulong Liu, Culver City, CA (US)

(21) Appl. No.: 18/368,253

(22) Filed: Sep. 14, 2023

(51) Int. Cl. G06N 3/0455; G06N 3/0475; G06N 3/08

(52) U.S. Cl. CPC G06N 3/0455; G06N 3/0475; G06N 3/08

(57) ABSTRACT

The present disclosure describes techniques for implementing dialog-based music recommendations for input videos. A video is input into a machine learning model. The machine learning model comprises a first sub-model and a second sub-model. At least one music track is identified by the first sub-model based on the input video. A first set of sentences is generated by the second sub-model. The first set of sentences depicts the at least one music track and recommendation reasons in natural languages. The first set of sentences is caused to be displayed on a computing device associated with a user. In response to receiving input indicating that the user prefers music different from the at least one music track, at least one other music track is identified. A second set of sentences depicting the at least one other music track in natural languages is generated for display on the computing device.

### BACKGROUND

Techniques for music recommendation are widely used in music and entertainment industries. Recently, the demand for music recommendation is getting even stronger. However, conventional music recommendation techniques may not fulfill the needs of users due to various limitations. Therefore, improvements in music recommendation techniques are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing dialog-based music recommendations for input videos.

FIG. 2 shows an example system for implementing dialog-based music recommendations for input videos.

FIG. 3 shows an example system for generating a conversational music recommendation dataset.

FIG. 4 shows an example first sub-model.

FIG. 5 shows an example first sub-model.

FIG. 6 shows an example system for implementing dialog-based music recommendations for input videos.

FIG. 7 shows an example process for implementing dialog-based music recommendations for input videos.

FIG. 8 shows an example process for generating simulated music recommendation conversations.

FIG. 9 shows an example process for training a machine learning model of implementing dialog-based music recommendations for videos.

FIG. 10 shows an example conversation when target music is retrieved in two turns.

FIG. 11 shows an example table illustrating music retrieval results.

FIG. 12 shows an example table illustrating a comparison of semantic similarity between output and simulated conversations using various metrics.

FIG. 13 shows an example computing device which may be used to perform any of the techniques disclosed herein.

### DETAILED DESCRIPTION OF ILLUSTRATIVE EMBODIMENTS

Music serves as a complementary modality within videos, enriching the viewer's video viewing experience and aiding in comprehension of the videos. Thus, choosing the right music for a video is crucial. Current music recommendation systems may effectively curate lists of tracks that harmonize with the content of a video. For example, current music recommendation systems may select scary music for a horror movie, or high-energy tracks for a dance video. While this focus on content compatibility is important, user preferences are equally important. For example, individuals born in the 1980s may prefer synth-pop for nostalgia-themed video, whereas teenagers might prefer contemporary pop for the videos they create. While both genres fall under the “pop” category, the choice between them can significantly impact user engagement with the video.

It is challenging to generate personalized music recommendations. While many systems leverage user profiles and activity data to generate recommendations, limitations still exist. One limitation of existing personalized music recommendations systems is the inability of such systems to consistently meet user preferences. A second limitation of existing personalized music recommendations systems is that they are unable generate personalized music recommendations for new users (e.g., users that are not associated with prior data). A third limitation of existing personalized music recommendations systems is that they provide lists of recommended songs based on user history, but these may not always align with user needs for specific videos. As such, existing personalized music recommendations systems result in a poor user experience, as they do not account for the complexity of predicting preferences. Improvements in personalized music recommendation techniques are desirable.

Described herein are improved techniques for personalized music recommendation. Described herein is an innovative dialog-based music recommendation system (e.g., MuseChat). Unlike existing systems that predominantly emphasize content compatibility (often overlooking the nuances of users' individual preferences), the system described herein offers interactive user engagement, and also suggests music tailored for input videos so that users can refine and personalize their music selections. The dialog-based music recommendation system described herein may comprise a first sub-model (e.g., multi-modal recommendation engine). The first sub-model may match music, either by aligning it with visual cues from the video and/or by harmonizing visual information, feedback from previously recommended music, and user textual input. The dialog-based music recommendation system described herein may comprise a second sub-model. The second sub-model may bridge music representations and textual data with a Large Language Model (LLM), such as Vicuna-7B and/or any other suitable LLM.

The dialog-based music recommendation system described herein may be configured to perform a conversation-synthesis method. The conversation-synthesis method may simulate a two-turn interaction between a user and a recommendation system. The method leverages pre-trained music tags and artist information. Users may submit a video to the system. In response, the system may suggest a suitable music piece, along with a rationale for why that music piece was suggested. Afterwards, users may provide feedback on the suggested music piece. In response to the user feedback, a refined music recommendation may be provided, along with a rationale as to why the refined music recommendation was suggested. Accordingly, the dialog-based music recommendation system described herein may deliver music recommendations and a reasoning as to why those music pieces are recommended in a manner resembling human communication. The dialog-based music recommendation system surpasses existing state-of-the-art models in music retrieval tasks and pioneers the integration of the recommendation process within a natural language framework.

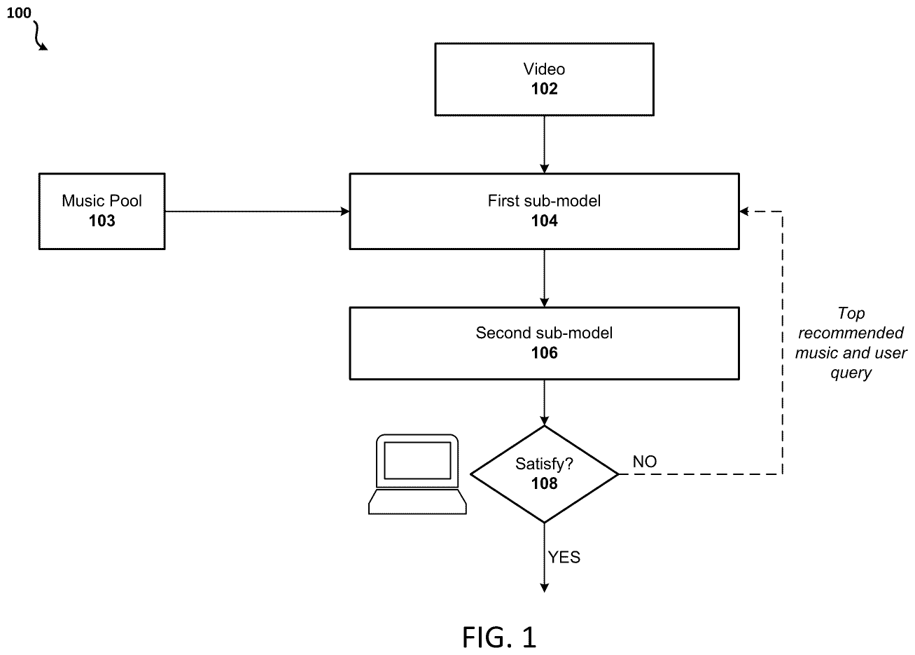

FIG. 1 shows an example comprehensive conversational music recommendation system 100. The system 100 may comprise a machine learning model. The machine learning model may comprise two main components: a first sub-model 104 (e.g., the music recommendation sub-model) and a second sub-model 106 (e.g., the sentence generator sub-model). The first sub-model 104 may be configured to operate in two modes. In the first mode, the first sub-model 104 may process just an input video 102 to select one or more tracks (e.g., pieces) of music to recommend from the music pool 103. The first sub-model 104 may send the music embedding(s) and title(s) associated with the selected track(s) of music to the second sub-model 106. The second sub-model 106 may receive, as input, the music embedding(s) and title(s) associated with the selected track(s) of music. The second sub-model 106 may generate natural language (e.g., words and/or sentences) that is associated with the music embedding(s) and title(s). For example, the second sub-model 106 may generate a first set of sentences that explain which music track(s) are recommended and/or a reasoning explaining why those music track(s) are recommended. The first set of sentences may be displayed on an interface of a computing device associated with a user.

At 108, the user may provide input indicating if the user prefers music different from the at least one music track. If the user provides input indicating that the user does not prefer music different from the at least one music track (e.g., the user is satisfied) and/or the user does not provide any input, the music recommendation process may be terminated. Conversely, if the user provides input indicating that the user prefers music different from the at least one music track (e.g., the user is not satisfied), the first sub-model 104 may operate in the second mode. In the second mode, the first sub-model may process the input video 102, the previously recommended music track(s), and the user input to select one or more different music tracks to recommend from the music pool 103.

The first sub-model 104 may send the music embedding(s) and title(s) associated with the selected different music track(s) to the second sub-model 106. The second sub-model 106 may receive, as input, the music embedding(s) and title(s) associated with the selected different music track(s). The second sub-model 106 may generate natural language (e.g., words and/or sentences) that is associated with the music embedding(s) and title(s). For example, the second sub-model 106 may generate a second set of sentences that explain that the different music track(s) are recommended and/or reasoning explanations why those different music track(s) are recommended. The second set of sentences may be displayed on the interface of the computing device associated with the user. This process may continue until the recommend music track(s) satisfy the user.

Users may have a difficult time interpreting how the inner systems of existing music recommendation models work, as these models usually function in a black-box fashion. As such, users are often not confident about the recommendations made by these existing systems. The system 100 remedies this problem, as the system 100 provides reasons for its music track recommendations. The system 100 may not only provide reasons for its music track recommendations to users, but the system 100 may also assist them in crafting their personal narratives with the music.

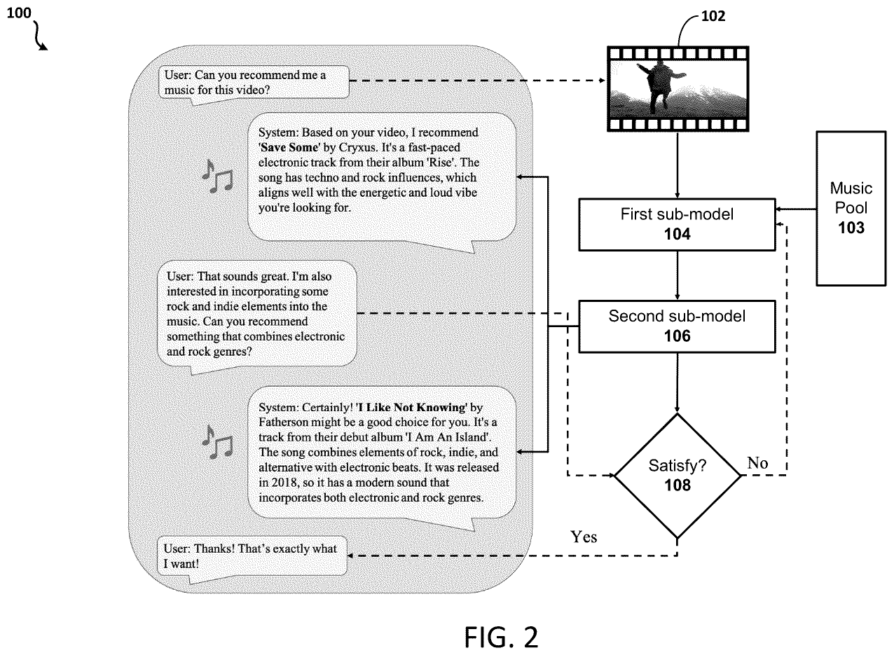

FIG. 2 shows the comprehensive conversational music recommendation system 100 of FIG. 1 in more detail. A user can upload the video 102 to the system 100 and receive one or more recommended music tracks. The user can interact with the system 100 in a conversational manner. At each dialog turn, the user can refine these recommendations by specifying criteria (e.g., mood, genre, instruments, theme, artist details, etc.) in natural language, until they identify a desired track.

A user input a video 102 to the system 100. The user may, using natural language, request a music track that corresponds to the input video 102. In response to the request, the first sub-model 104 may process only the input video 102 to select one or more tracks (e.g., pieces) of music to recommend from the music pool 103. The first sub-model 104 may send the music embedding(s) and title(s) associated with the selected track(s) of music to the second sub-model 106. The second sub-model 106 may receive, as input, the music embedding(s) and title(s) associated with the selected track(s) of music. The second sub-model 106 may generate natural language (e.g., words and/or sentences) that is associated with the music embedding(s) and title(s). The second sub-model 106 may generate a first set of sentences that explain which music track(s) are recommended and/or reasoning explanation(s) why those music track(s) are recommended. In the example of FIG. 2, the first set of sentences recommends the music track “Save Some.” The first set of sentences also explains why the music track “Save Some” is recommended. The first set of sentences may be displayed on an interface of a computing device associated with a user.

The user may view the recommendation of the music track “Save Some.” The user may decide that he or she wants a different music track for the video 102. The user may provide input indicating that the user prefers music different from the at least one music track. For example, the user may provide input (e.g., in natural language) indicating that the user wants a music track that combines the electronic and rock genres. The first sub-model 104 may process the input video 102, the previously recommended music track “Save Some,” and the user input to select one or more different music tracks to recommend from the music pool 103.

The first sub-model 104 may send the music embedding(s) and title(s) associated with the selected different music track(s) to the second sub-model 106. The second sub-model 106 may receive, as input, the music embedding(s) and title(s) associated with the selected different music track(s). The second sub-model 106 may generate natural language (e.g., words and/or sentences) that is associated with the music embedding(s) and title(s). For example, the second sub-model 106 may generate a second set of sentences that explain that the different music track(s) are recommended and/or reasoning explanation(s) why those different music track(s) are recommended. In the example of FIG. 2, the second set of sentences recommends the music track “I Like Not Knowing.” The second set of sentences also explains why the music track “I Like Not Knowing” is recommended. The second set of sentences may be displayed on the interface of the computing device associated with the user. This process may continue until the recommend music track(s) satisfy the user.

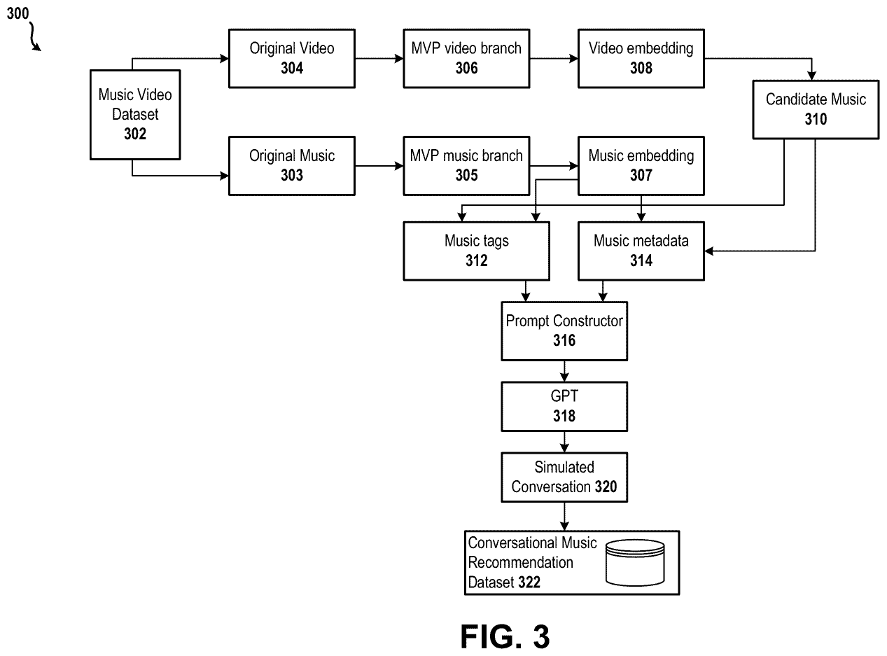

Constructing the system 100 presents three core challenges. First, existing datasets primarily comprise music-video pairs, music-text pairs, or music-text-video triplets. These datasets do not align well with training the system 100. For example, such datasets only include single-turn interactions, lacking the multi-turn dialogues that are crucial for more interactive and dynamic recommendation systems. Further, these datasets omit explanations for the recommendations, a key feature for enhancing user understanding and trust. To address these challenges, the system 100 is trained on a novel dataset tailored for dialogue-driven music recommendations and reasoning within the context of videos. The data contains 98,206 quartets: a video, original music, candidate music and a two-turn conversation. This setup mimics user interaction with recommendation systems. Generation of this novel dataset is described in more detail below with regard to FIG. 3.

A second challenge associated with constructing the system 100 relates to joint multimodality learning. The task of creating a joint embedding space for video, music, and text is complex. Each of these modalities has its unique sequential features, making it a challenge to combine them into a unified representation. The system 100 effectively integrates spatiotemporal information from these diverse modalities, leading to a more holistic representation. In particular, the first sub-model 104 comprises a tri-modal architecture designed for music-video matching, enhanced with textual input. Therefore, the first sub-model 104 not only processes the previously recommended music and video content, but also integrates user-provided textual prompts to fine-tune its music recommendations.

A third challenge associated with constructing the system 100 relates to prediction reasoning. While current research on multi-modality large language models (MLLMs) exhibit capabilities to process and understand diverse modalities, such as video and audio, a significant gap exists. Specifically, none of these models are built for the nuanced task of music interpretation and recommendation. The second sub-system 106 is able to articulate the reasoning behind its music recommendations by harnessing the capabilities of LLMs. Drawing on music representation from an upstream module, the second sub-system 106 deeply understands musical features and subsequently produces coherent reasoning outputs, guaranteeing a harmonious alignment between music and textual descriptors.

As described above, the system 100 is trained on a novel dataset tailored for dialogue-driven music recommendations and reasoning within the context of videos. FIG. 3 shows a system 300 for generating the dataset (e.g., conversational music recommendation dataset). The system 300 may be generated by simulating a two-turn dialog to create one data sample. In the first turn, only video may be provided, and a candidate music track may be recommended by an underlying music recommendation system. In the second turn, based on the recommended music, simulated user dialogue (e.g., in natural language) may prompt changes to the target music, along with video and the recommended music. The system 100 may output another recommended music track that matches the video most.

A music video dataset 302 (e.g., YouTube-8M dataset) may be used to construct the conversational music recommendation dataset. The music video dataset 302 may comprise a large-scale video collection. The music video dataset 302 may comprise hundreds of thousands or millions of music video IDs and associated labels spread across thousands of classes, including genres like music, sports, documentaries, etc. The music video dataset 302 may serve as an invaluable dataset for video understanding, especially for fields like music recognition and categorization within the broader spectrum of video research. Videos tagged with “music video” may be filtered out from the music video dataset 302. Any unavailable videos may be removed. The resulting dataset may comprise 98,206 music videos. From each video, a clip (e.g., a 120-second clip) may be extracted. The clip may focus on the central segment in the video. A portion (e.g., 88,000) of these music videos may be randomly allocated to the training set. The remaining portion (e.g., the remaining 10,206 videos) may be allocated to the testing set. Each video and its corresponding music may be set as the ground truth (e.g., video and target music).

A music-video pretrained (MVP) model may be utilized to generate the conversational music recommendation dataset. The MVP model may comprise a video branch 306 and a music branch 305. The video branch 306 may utilize a pretrained CLIP Image encoder for video feature extraction. The music branch 305 may utilize a pretrained audio spectrogram transformer (AST) for music feature extraction. The MVP model may be trained on a dataset consisting of millions of music-video pairs.

The MVP model receives both candidate music and video as input. The MVP model outputs a similarity score. The similarity score may indicate, for each candidate music item, a similarity (e.g., cosine similarity score) between the candidate music item and the input video. Music from a music pool may then be ranked in the order of decreased similarity (e.g., the music that is most similar to the video is ranked the highest). In embodiments, the pool of candidate music may be restricted for training and for testing (e.g., to 2000 candidate music items and 500 for testing). Original music may be excluded from both the training and testing set. Restricting the candidate pool may ensure that the recommendations are not affected by low quality music. The MVP model is not intended to identify the track that most similar to the original. Rather, the MVP model is configured to identify a track that represents a noticeable divergence from a prior recommendation with which the user may not be fully satisfied.

Given a triplet consisting of a video, its original music track, and a recommended candidate music track, the system 300 may be used to construct a two-turn conversation. Specifically, during each user turn, a prompt constructor 316 may provide a prompt to bridge the original music and the current recommended candidate music. During the bot's turn, descriptions about the returned music (e.g., the recommended candidate music in the first turn, and the original music in the second turn) are essential.

Music tags 312 may be assigned to each music track. The music tags 312 may efficiently summarize songs by providing descriptive keywords that cover various elements (e.g., emotion, genre, and theme). The music tags 312 may be generated using a model that uses shallow convolutional layers to extract acoustic features. The acoustic features may then be processed by stacked self-attention layers in a semi-supervised setting. The music tags 312 may be generated by leveraging one or more separate systems. The system(s) may have a 50-tag vocabulary. Using more than one system for generating the music tags 312 may enhance the tagging robustness. Music metadata 314 may be collected for every music video. Music metadata 314 may indicate a title and/or video description of the music video. The music metadata 314 may indicate official artist names, album specifics, and/or release dates.

The music tags 312 and the music metadata 314 may be fed into the prompt constructor 316. The prompt constructor 316 may utilize the music tags 312 and the music metadata 314 to generate prompts for guiding a chat generative pre-trained transformer 318 to generate a two-turn conversation (e.g., simulated conversation 320) between a user and a music recommendation system. The GPT 318 may receive the prompts from the prompt constructor 316. The GPT 318 may utilize one or more of the prompts, the music tags 312, and the music metadata 314 to generate the simulated conversation 320. The simulated conversation 320 may be used to generate the conversational music recommendation dataset 322. Each instance (e.g., entry) in the conversational music recommendation dataset 322 contains a video v, original target music track mₜ, candidate music track m_{c} and simulated conversation text t. More specifically, tᵢ represents the sequence order of each conversational turn: t₁ and t₃ are from users, while t₂ and t₄ are from the recommendation system.

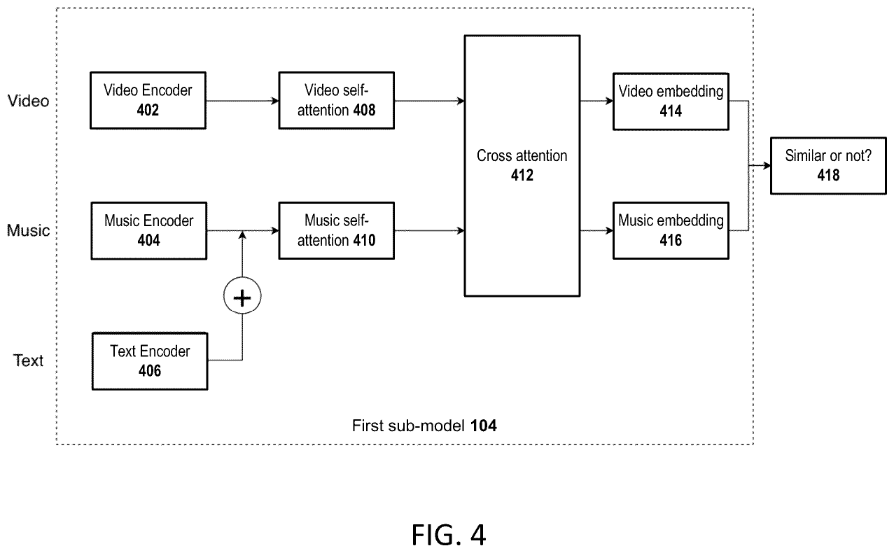

FIG. 4 shows an example of the first sub-model 104. The first sub-model 104 may be trained on the conversational music recommendation dataset 322. The first sub-model 104 incorporates three types of inputs: video, music, and text. The first sub-model 104 may comprise a video encoder 402. The video encoder 402 may be configured to extract base embeddings from video. The video encoder 402 may utilize a multi-modal vision and language model (e.g., CLIP) to extract base embeddings from video. The base embeddings extracted from the video may be fed into a video self-attention layer 408. The video self-attention layer 408 may enable the first sub-model 104 to weigh the importance of the different base embeddings extracted from the video and dynamically adjust their influence on the output. The output of the video self-attention layer 408 may be fed into a cross-attention model 412.

The first sub-model 104 may comprise a music encoder 404. The music encoder 404 may be configured to extract representations from music. The music encoder 404 may utilize an audio spectrogram transformer (AST) to extract the representations from music. The first sub-model 104 may comprise a text encoder 406. The text encoder 406 may be configured to extract base embeddings from text. The text encoder 406 may utilize a multi-modal vision and language model (e.g., CLIP) to extract base embeddings from text. The representations extracted from the music and the base embeddings extracted from the text may be combined. The combination may be fed into a music self-attention model 410. The music self-attention model 410 may enable the first sub-model 104 to weigh the importance of the different representations extracted from the music and base embeddings extracted from the text and dynamically adjust their influence on the output.

The output of the music self-attention layer 410 may be fed into the cross-attention model 412. The cross-attention model 412 may receive the output of the video self-attention layer 408 and the output of the music self-attention layer 410. The cross attention model 412 may fuse the output of the video self-attention layer 408 and the output of the music self-attention layer 410. The fused features, rich in contextual information, may be combined with video embeddings 414 and music embeddings 416, resulting in significant improvements.

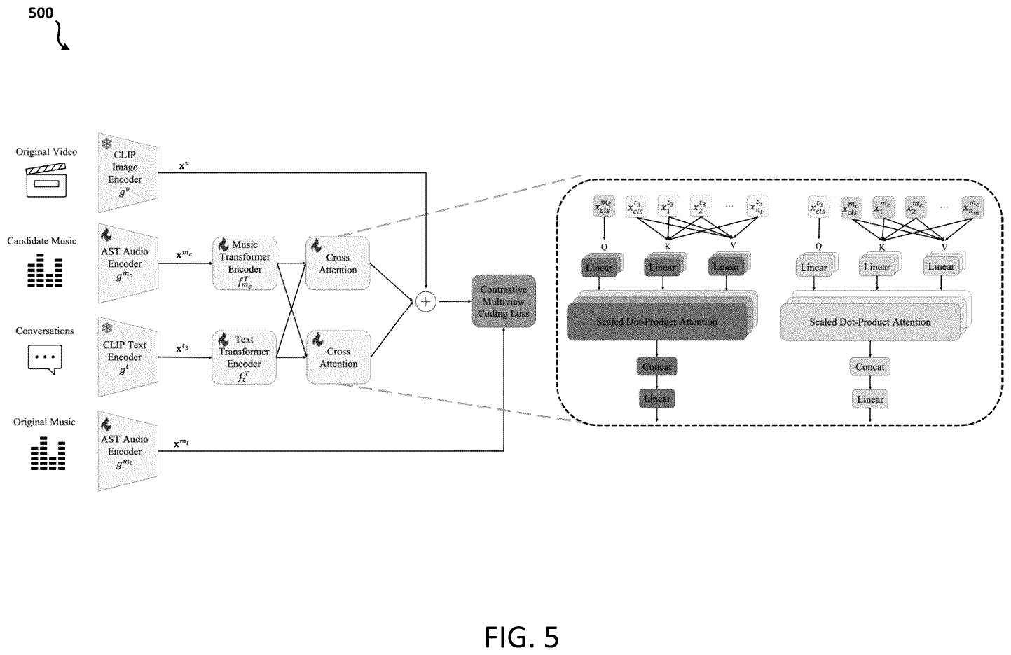

FIG. 5 shows the first sub-model 104 in more detail. The first sub-model 104 may be trained on the conversational music recommendation dataset 322. Each training sample in the conversational music recommendation dataset 322 is defined as a quartet (v, m_{c}, mₜ, t₃), where v is the video, m_{c} denotes the candidate music track, mₜ is the target original music track, and t₃ is the text of user's preferences. The first sub-model 104 is trained to transition a music track recommendation from a previous track m_{c} to target music track mₜ.

The first sub-model 104 may be trained to select the most relevant music from a music pool, using a variety of inputs such as video, music and text. The first sub-model 104 may incorporate three types of inputs: video, music, and text. Each training sample may be transformed into base features: x^{v}=g^{v}(v) for visual inputs, x^{t}^{₃}=g^{t}^{₃}(t₃) for text inputs, x^{m}^{ₜ}=g^{m}^{ₜ}(mₜ) and x^{m}^{_{c}}=g^{m}^{_{c}}(m_{c}) for audio inputs. g^{v} and g^{t} may be frozen during training, while g^{m}^{ₜ}, and g^{m}^{_{c}} may be subject to fine tuning. To transform each training sample into base features, the first sub-model 104 may be configured to extract base embeddings from video. The first sub-model 104 may utilize a multi-modal vision and language model (e.g., CLIP encoder) to extract base embeddings from video. The first sub-model 104 may be configured to extract base embeddings from text. The first sub-model 104 may utilize a multi-modal vision and language model (e.g., CLIP encoder) to extract base embeddings from the text. The first sub-model 104 may be configured to extract representations from candidate music and/or from the original music. The first sub-model 104 may be configured to extract representations from candidate music using a first AST. The first sub-model 104 may be configured to extract representations from original music using a second AST.

In embodiments, since these features come from different backbone models, a trainable linear projection layer may be used to map them into a common embedding space. This results in x^{t}^{₃}∈Rⁿ^{ₜ}^{×d} and x^{m}^{_{c}}∈Rⁿ^{ₘ}^{×d}. Given the aim to align the target music track mₜ with the overall video content, the sequence dimension of each x^{v} may be averaged to yield x^{\tilde{v}}∈R^{1×d}. To summarize the target music, the first cls token from x^{m}^{ₜ} may be used, resulting in x^{m}^{ₜ}^{^{cls}}∈R^{1×d}.

To better capture the information from audio and text, latent features from candidate music and from text may be encoded using transformer layers. For example, a transformer encoder may be applied to both the audio and text, denoted fₘ_{_{c}}^{T} and fₜ^{T} respectively, to capture long-range dependencies and complex relationships in the sequence data. This yields:

$${\tilde{x}}^{{t}_{3}} = {f}_{t}^{T} ( {x}^{{t}_{3}} )$$

$${\tilde{x}}^{{m}_{c}} = {f}_{{m}_{c}}^{T} ( {x}^{{m}_{c}} ) .$$

In embodiments, the encoded latent features from the candidate music and from the text may be fused using a multi-head cross-attention layer. The transformed features \tilde{x}^{t}^{₃} and \tilde{x}^{m}^{_{c}} may be represented as the following sequences:

$${\tilde{x}}^{{t}_{3}} = [ {\tilde{x}}_{cls}^{{t}_{3}} , {\tilde{x}}_{1}^{{t}_{3}} , … , {\tilde{x}}_{( {n}_{t} )}^{{t}_{3}} ]$$

$${\tilde{x}}^{{m}_{c}} = [ {\tilde{x}}_{cls}^{{m}_{c}} , {\tilde{x}}_{1}^{{m}_{c}} , … , {\tilde{x}}_{( {n}_{m} )}^{{m}_{c}} ] ,$$

where cls serves as a summary of the respective sequence, along with the other elements capturing detailed features. The multi-head cross-modality attention layer may be defined as:

$$Attn ( Q , K , V ) = softmax ( \frac{Q {K}^{T}}{\sqrt{{d}_{k}}} ) V ,$$

where dₖ is the dimensionality of key vectors. Q and K, V are from two different modalities.

In embodiments, \tilde{x}^{t}^{₃} and \tilde{x}^{m}^{_{c}} may be fused to generate the following final fusion embeddings:

$${x}^{f} = {x}^{\overline{v}} + Attn ( {\tilde{x}}_{cls}^{{r}_{3}} , {\tilde{x}}^{{m}_{c}} , {\tilde{x}}^{{m}_{c}} ) + Attn ( {\tilde{x}}_{cls}^{{m}_{c}} , {\tilde{x}}^{{t}_{3}} , {\tilde{x}}^{{m}_{c}} ) .$$

The fused features, rich in contextual information, may be combined with the extracted video embeddings, resulting in significant improvements.

In embodiments, during training, a contrastive multi-view coding loss function may be used. For each batch B, the following ranking loss may be used:

$${L}_{R} = - {\sum }_{i = 1}^{B} log [ \frac{h [ ( {x}_{( i )}^{f} ) , ( {x}_{( i )}^{{m}_{t}^{cls}} )}{{\sum }_{j \neq 1} h ( {x}_{( i )}^{f} , {x}_{( j )}^{{m}_{t}^{c l s}} ) + h ( {x}_{( j )}^{f} , {x}_{( i )}^{{m}_{t}^{c l s}} )} ] ,$$

where x₍ᵢ₎^{f} and

$${x}_{( i )}^{{m}_{t}^{c l s}}$$

are i-th fusion vectors and target music representations in the batch respectively.

$$h ( x , y ) = {exp}^{{x}^{T} y} / τ$$

is a discriminating function, and t the temperature hyperparameter, and t is a trainable hyperparameter. Larger batch sizes may be beneficial in contrastive learning.

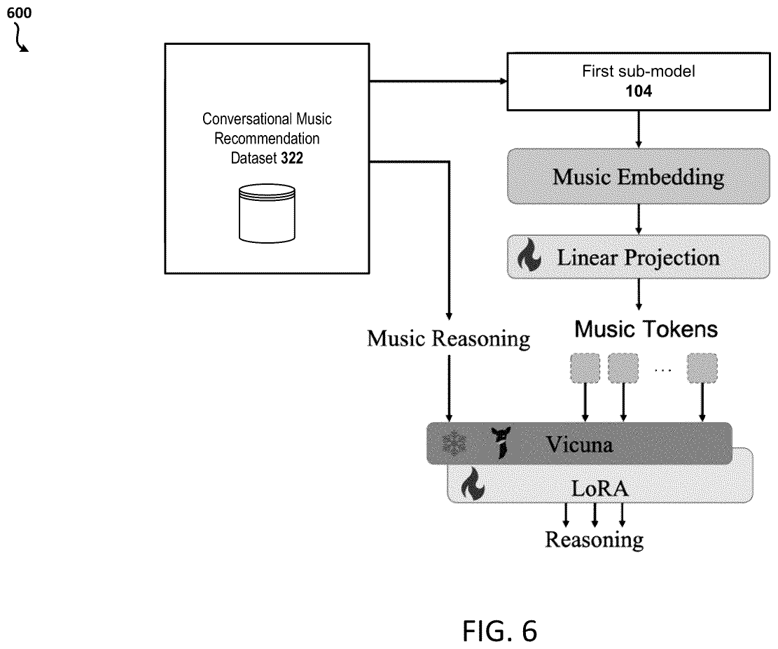

FIG. 6 shows the second sub-model 106 in more detail. During training of the second sub-model 106, only the linear projection layers and the additional Low-Rank Adaptation of Large Language Models (LoRA) weights may be trained. LoRA is a training method that accelerates the training of large models while consuming less memory. It adds pairs of rank-decomposition weight matrices (called update matrices) to existing weights, and only trains those newly added weights. The parameters of Vicuna-7B may be kept frozen during training. A multi-modal LLM based on Vicuna-7B may be built by finetuing Llama2-7B weights. Each training instance may comprise a music representation x^{m}^{ₜ} from the first sub-model 104 music encoder and the corresponding recommendation reasoning statement t₄ from the simulated conversation in the conversational music recommendation dataset 322. To align music representation x^{m}^{ₜ} with a text embedding space, linear projection fₗ may be trained to connect the music representation x^{m}^{ₜ} to Vicuna. To reduce the number of trainable parameters, LoRA may be leveraged to finetune the Vicuna's attention structures.

In embodiments, during training, a loss function may be used:

$${L}_{G} ( y , θ ) = {\prod }_{i = 1}^{n} {p}_{θ} ( {y}_{i} \vert [ {f}_{l} ( {x}^{{m}_{t}} ) : {x}^{{t}_{4}} ] ; θ ) ,$$

where yᵢ is the i-th token in the response y, and θ is the trainable parameters in linear projection layers and LoRA weights.

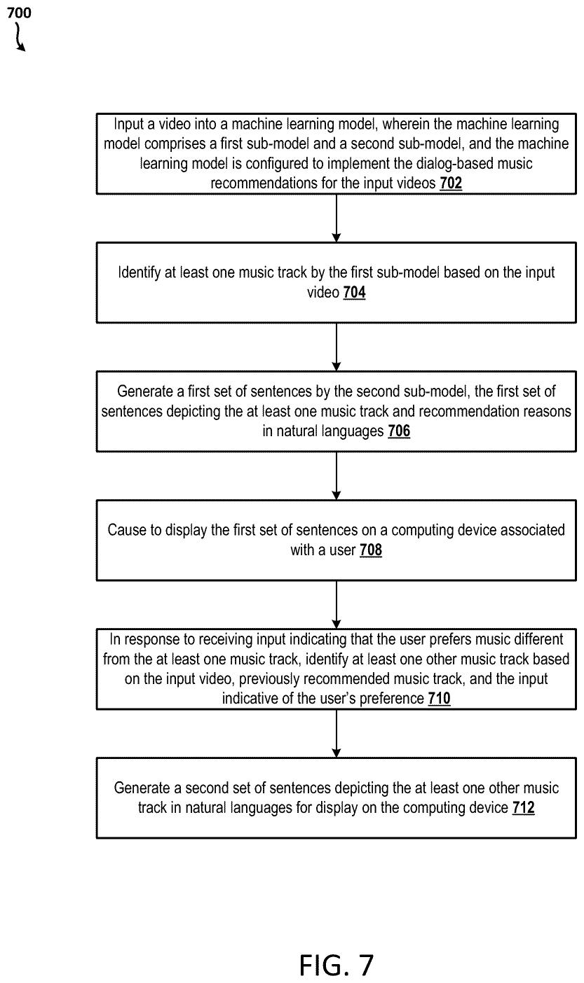

FIG. 7 illustrates an example process 700 for implementing dialog-based music recommendations for input videos. Although depicted as a sequence of operations in FIG. 7, those of ordinary skill in the art will appreciate that various embodiments may add, remove, reorder, or modify the depicted operations.

At 702, a video may be input into a machine learning model. The video may be received from (e.g., uploaded by) a user. The machine learning model may be configured to implement the dialog-based music recommendations for input videos. The machine learning model may comprise a first sub-model and a second sub-model. The first sub-model may be configured to operate in two modes. In the first mode, the first sub-model may process just the input video. The first sub-morel may process just the input video to identify one or more music tracks that correspond to the input video. At 704, at least one music track may be identified. The at least one music track may be identified by the first sub-model based on the input video. The first sub-model may send an indication of the at least one music track (e.g., music embedding(s) and title(s) associated with the at least one music track) to the second sub-model.

The second sub-model may receive the indication of the at least one music track. At 706, a first set of sentences may be generated. The first set of sentences may be generated by the second sub-model. The first set of sentences may indicate or depict the at least one music track. The first set of sentences may be written in natural language (e.g., language that has developed naturally in use as contrasted with an artificial language or computer code). Recommendation reasons may additionally be generated. The recommendation reasons may explain (e.g., in natural language) why the at least one music track is recommended. At 708, the first set of sentences may be caused to be displayed. The first set of sentences maybe caused to be displayed on a computing device. The computing device may be associated with a user (e.g., the user that uploaded the video).

The user may prefer music different from the at least one music track. The user may generate input (e.g., in natural language) indicating that the user prefers music different from the at least one music track. The user may generate the input (e.g., written or audio) using a keyboard, microphone, touch screen device, and/or the like. The input may indicate one or more features of the different music that the user prefers. At 710, at least one other music track may be identified. The at least one other music track may be identified in response to receiving input indicating that the user prefers music different from the at least one music track. The at least one other music track may be identified based on the input video, previously recommended music track, and the input indicative of the user's preference. The at least one other music track may be identified by the first sub-model. The first sub-model may send an indication of the at least one other music track (e.g., music embedding(s) and title(s) associated with the at least one other music track) to the second sub-model.

The second sub-model may receive the indication of the at least one other music track. At 712, a second set of sentences may be generated. The second set of sentences may depict the at least one other music track. The second set of sentences may be written in natural language (e.g., language that has developed naturally in use as contrasted with an artificial language or computer code). Recommendation reasons may additionally be generated. The recommendation reasons may explain (e.g., in natural language) why the at least one other music track is recommended. The second set of sentences may be generated for display on the computing device.

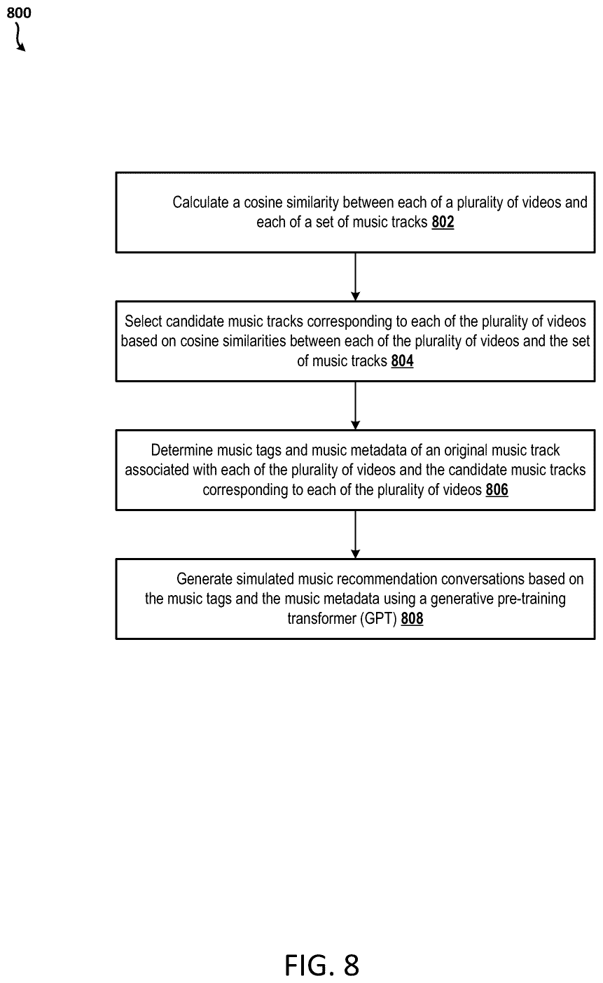

FIG. 8 illustrates an example process 800 for generating simulated music recommendation conversations. Although depicted as a sequence of operations in FIG. 8, those of ordinary skill in the art will appreciate that various embodiments may add, remove, reorder, or modify the depicted operations.

A music-video pretrained (MVP) model may be utilized to generate a conversational music recommendation dataset. The MVP model may comprise a video branch and a music branch. The MVP model may be trained on a dataset consisting of millions of music-video pairs. The MVP model may receive a plurality of videos and a set of music tracks. At 802, a similarity (e.g., cosine similarity) between each of the plurality of videos and each of the set of music tracks may be calculated. The similarity may indicate, for each candidate music track item, a similarity between the music track and each video. Music from the set of music tracks may then be ranked in the order of decreased similarity for each video (e.g., the music that is most similar to a video is ranked the highest for that video). At 804, candidate music tracks may be selected. The candidate music tracks may correspond to each of the plurality of videos. The candidate music tracks may be selected based on cosine similarities between each of the plurality of videos and the set of music tracks. For example, the candidate music tracks corresponding to a particular video may be the music tracks with the highest similarity to the video.

At 806, music tags and music metadata may be determined. The music tracks and the music metadata may be associated with an original music track associated with each of the plurality of videos and the candidate music tracks corresponding to each of the plurality of videos. The music tags may efficiently summarize songs by providing descriptive keywords that cover various elements (e.g., emotion, genre, and theme). Music metadata may indicate a title and/or video description of the music video. The music metadata may indicate official artist names, album specifics, and/or release dates. At 808, simulated music recommendation conversations may be generated. The simulated music recommendation conversations may be generated based on the music tags and the music metadata. The simulated music recommendation conversations may be generated using a generative pre-training transformer (GPT). For example, a prompt constructor may utilize the music tags and the music metadata to generate prompts for guiding the GPT to generate a two-turn conversation (e.g., simulated conversation) between a user and a music recommendation system. The GPT may receive the prompts from the prompt constructor. The GPT may utilize one or more of the prompts, the music tags, and the music metadata to generate the simulated conversation. The simulated conversation may be used to generate a conversational music recommendation dataset.

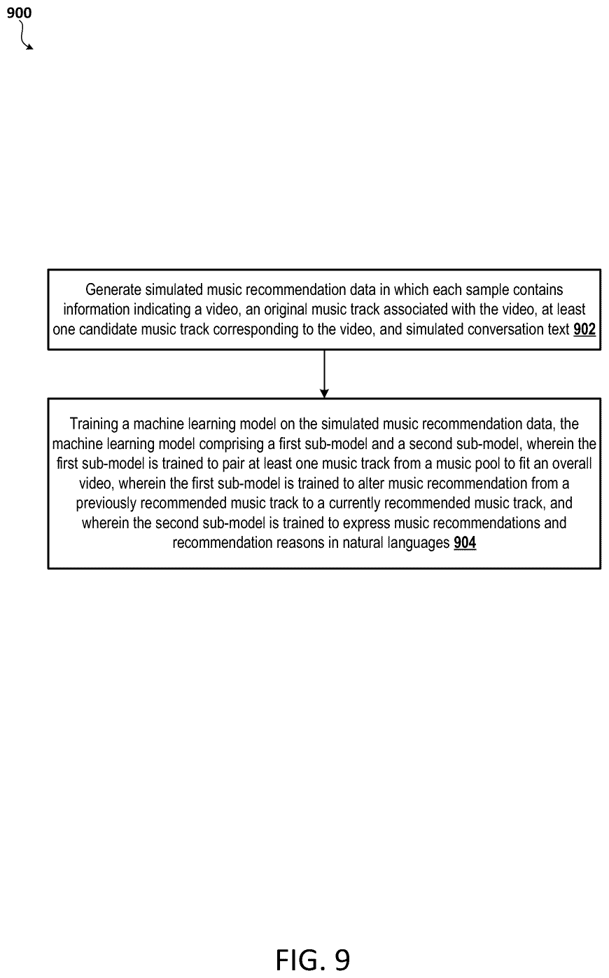

FIG. 9 illustrates an example process 900 for training a machine learning model of implementing dialog-based music recommendations for videos. Although depicted as a sequence of operations in FIG. 9, those of ordinary skill in the art will appreciate that various embodiments may add, remove, reorder, or modify the depicted operations.

At 902, simulated music recommendation data may be generated. Each sample (e.g., training sample, instance, etc.) of the simulated music recommendation data may contain information indicating a video, an original music track associated with the video, at least one candidate music track corresponding to the video, and simulated conversation text. At 904, a machine learning model may be trained. The machine learning model may be trained on the simulated music recommendation data. The machine learning model may comprise a first sub-model and a second sub-model. The first sub-model may be trained to pair at least one music track from a music pool to fit an overall video. The first sub-model may be trained to alter a music recommendation from a previously recommended music track to a currently recommended music track. The second sub-model may be trained to express music recommendations and recommendation reasons in natural languages (e.g., language that has developed naturally in use as contrasted with an artificial language or computer code).

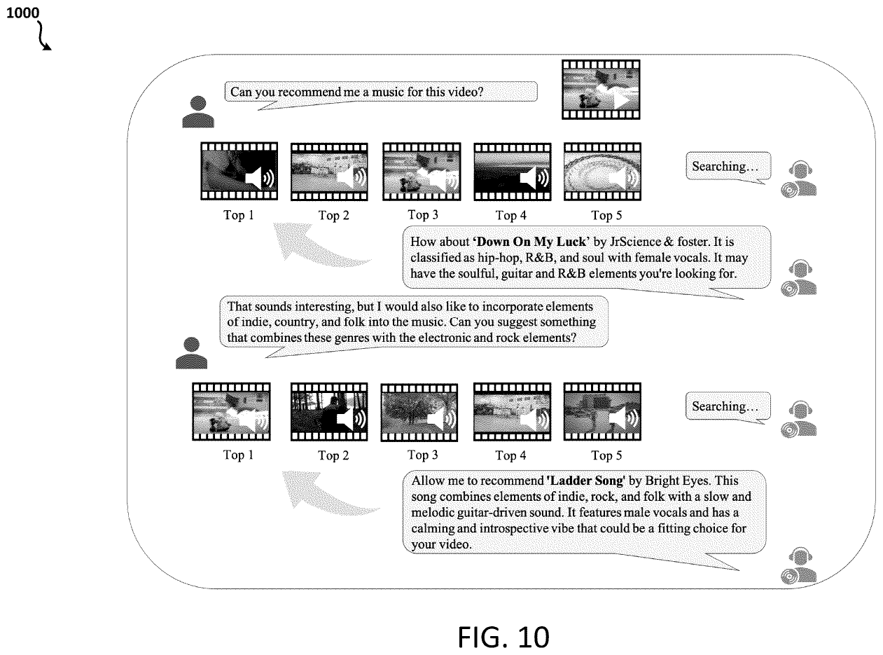

FIG. 10 shows an example conversation 1000 when target music is retrieved in two turns. The example conversation 1000 highlights the versatility and efficacy of the system described herein. The example conversation 100 illustrates how the system described herein seamlessly interacts with users, dynamically adjusting its recommendations based on the video content, user preferences, and contextual information about the music.

In the first turn, the first sub-model may process an input video to select one or more tracks (e.g., pieces) of music to recommend from a music pool. The first sub-model may send the music embedding(s) and title(s) associated with the selected track(s) of music to the second sub-model. The second sub-model may receive, as input, the music embedding(s) and title(s) associated with the selected track(s) of music. The second sub-model may generate natural language (e.g., words and/or sentences) that is associated with the music embedding(s) and title(s). For example, the second sub-model may generate a first set of sentences that explain which music track(s) are recommended and/or reasoning explanation(s) why those music track(s) are recommended. The first set of sentences may be displayed on an interface of a computing device associated with a user. In the example of FIG. 10, the first set of sentences recommends the music track “Down on My Luck” and explains why the music track “Down on My Luck” is being recommended.

The user may want a music track different than “Down on My Luck.” The user may provide input explaining (e.g., in natural language) that the user prefers music different from the music track “Down on My Luck.” The user input may explain one or more features that the user wants the different music track to have. In the second turn, the first sub-model may process the input video, the previously recommended music track “Down on My Luck,” and the user input to select one or more different music tracks to recommend from the music pool.

The first sub-model may send the music embedding(s) and title(s) associated with the selected different music track(s) to the second sub-model. The second sub-model may receive, as input, the music embedding(s) and title(s) associated with the selected different music track(s). The second sub-model may generate natural language (e.g., words and/or sentences) that is associated with the music embedding(s) and title(s). For example, the second sub-model may generate a second set of sentences that explain that the different music track(s) are recommended and/or a reasoning explanation why those different music track(s) are recommended. The second set of sentences may be displayed on the interface of the computing device associated with the user. In the example of FIG. 10, the second set of sentences recommends the music track “Ladder Song” and explains why the music track “Ladder Song” is being recommended.

The comprehensive conversational music recommendation system described herein may perform better than existing music recommendation systems. Experiments were conducted to assess the performance of the comprehensive conversational music recommendation system described herein. Each of a plurality of 120-second music video clips were divided into twelve 10-second segments and 5 frames per second were captured from each segment. In the training process for the first sub-model 104, each training sample included a 10-second video clip, a corresponding 10-second original music clip, a 10-second candidate music clip, and a user prompt. A CLIP model was used to extract video and text features. An AST model was used to extract audio features. These basic features were converted into 256-sized embeddings using a linear projection for each input type. Following this, four Transformer encoder layers and a multi-head cross-attention layer, each with 16 heads, were applied, to process these embeddings. In the second sub-model 106, the maximum sequence length was limited to 128 and the temperature hyperparameter was set at 0.1.

The ranking ability of the first sub-model 104 was evaluated. The test set included a total of 10,206 music tracks. Each of these music tracks was randomly divided into 20 different music pools, with each pool containing over 500 music tracks. Importantly, each pool has only one correct music track for each video. For the track-level testing, embeddings were calculated for all 12 segments of each 120-second video and music track. The average of these 12 embeddings was used to create a single representative embedding for each video and each music track. Using these averaged embeddings, the performance of the first sub-model 104 was evaluated. In the first turn, music is suggested based solely on video features, as it can be assumed that the user has not provided any specific requirements at this point. In the second turn, the user's text prompts and candidate music were included along with the video features. This setup was used to evaluate the system's ability to modify its initial recommendations based on the new information. For both turns, music tracks were ranked by calculating the cosine similarity between the features of the music in the pool and the input features. Various metrics were then computed. The metrics included, for example, Recall@K for K=1, 5, 10, median rank, and the “success rate at 10” (abbreviated as SR@10). The success rate at 10 gauges the percentage of videos for which the correct music track appears in the top 10 recommended list within two turns. The average performance for each of these metrics was evaluated across all test music pools.

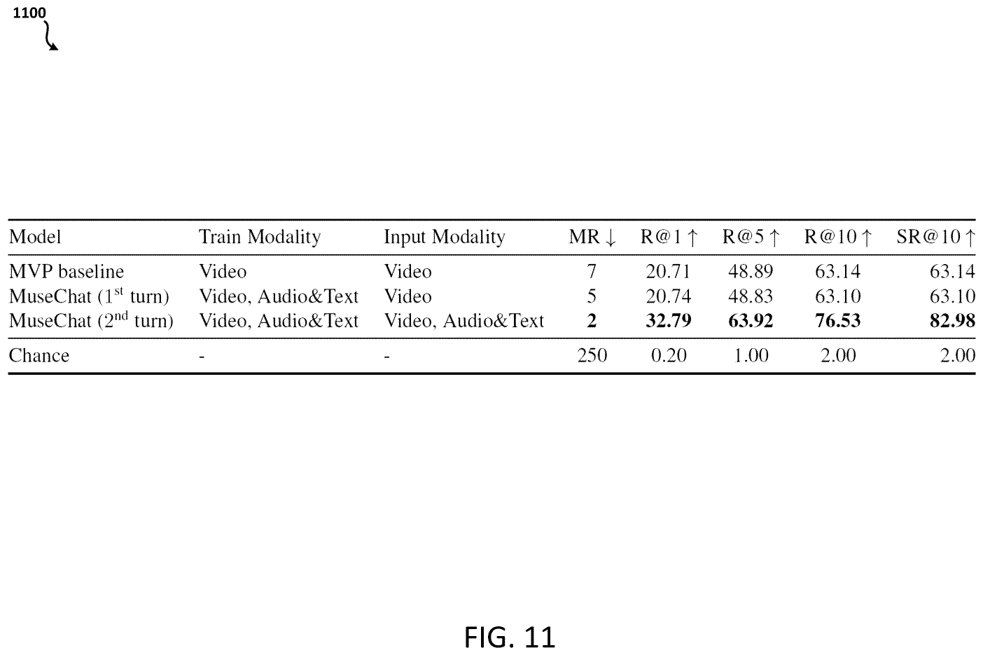

To assess the effectiveness of the conversational recommendation system described herein (e.g., MuseChat), a strong baseline model with a two-tower structure was developed. This baseline model shares the same encoder model as MuseChat for handling video and the original music track, but it lacks the ability to handle text data. Both the baseline and MuseChat were trained using the same dataset and loss function. FIG. 11 shows an example table 1100. The table 1100 summarizes the music retrieval results for the baseline, multi-turn MuseChat. The performance of different models were evaluated under various input conditions. MuseChat, trained on fused features from three different modalities, performs comparably to the baseline when only visual information is given in the first turn. However, when additional modalities are introduced in the second turn, an improvement exceeding 10% was observed across metrics. As shown in the table 1100, MuseChat greatly outperforms the baseline model for all metrics on the second turn.

The second sub-model 106 was evaluated. To underscore the importance of training the second sub-model 106 with both music embeddings and music titles as inputs, two baseline models were introduced for comparison. The first baseline employs the frozen Vicuna-7B model, which is based on the Llama2-7B architecture. As this model cannot process music embeddings, it was only presented with the recommended music title. The second baseline utilizes the same architecture as the second sub-model 106 but takes only music embeddings as input. Various common metrics were employed to evaluate the performance of these baseline models and the second sub-model 106 on simulated conversations.

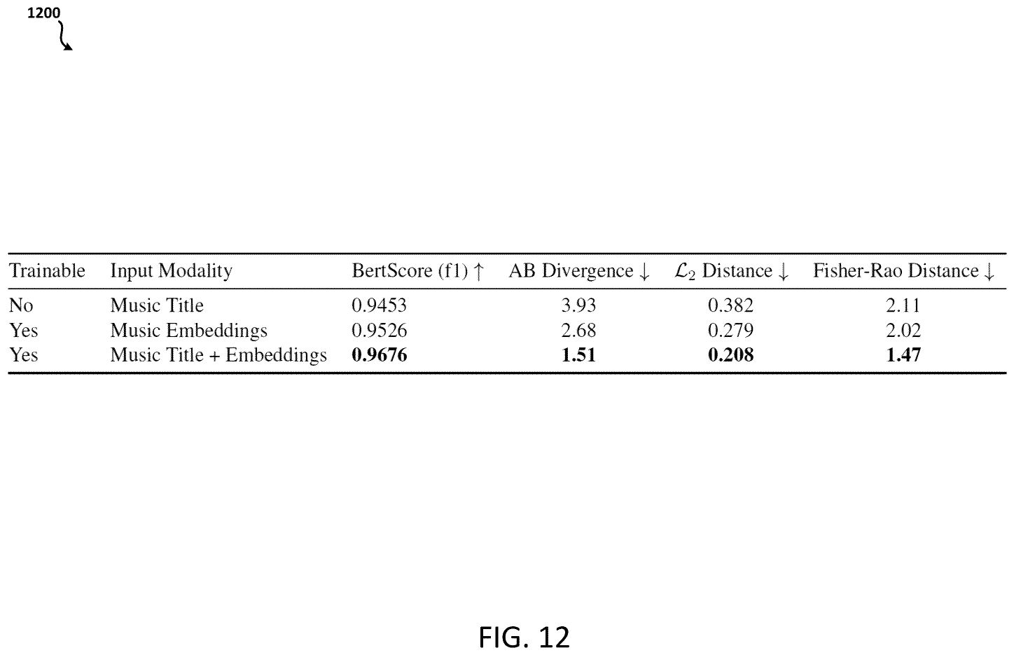

FIG. 12 shows an example table 1200. The table 1200 shows a comparison of semantic similarity between output and simulated conversations using various metrics. The BERTScore assesses token-level similarity, while AB Divergence, L2 Distance, and Fisher-Rao Distance are derived based on InfoLM. As shown in the table 1200 of FIG. 12, the Vicuna-7B model performs the worst. This is largely because it fails to extract the music name and artist name from the given music video title, thus lacking a comprehensive understanding of the recommended track. Even when this information is explicitly provided, the model struggles to grasp the musicality of the given track, as it was solely trained on text modality. As for the second baseline, while it successfully captures the musical essence of the recommended track due to its training on both music and text modalities, it still falls short. The model cannot accurately identify the correct music name and artist name based solely on audio information. In contrast, the second sub-model 106, which uses both audio information and music title inputs, outperforms the baselines, demonstrating the efficacy of the techniques described herein.

In conclusion, conventional music recommendation systems primarily focus on delivering personalized suggestions through implicit methodologies, which may not always capture the true preferences of users. The techniques described herein enable the generation of recommendation outputs that are more accurately tailored to users.

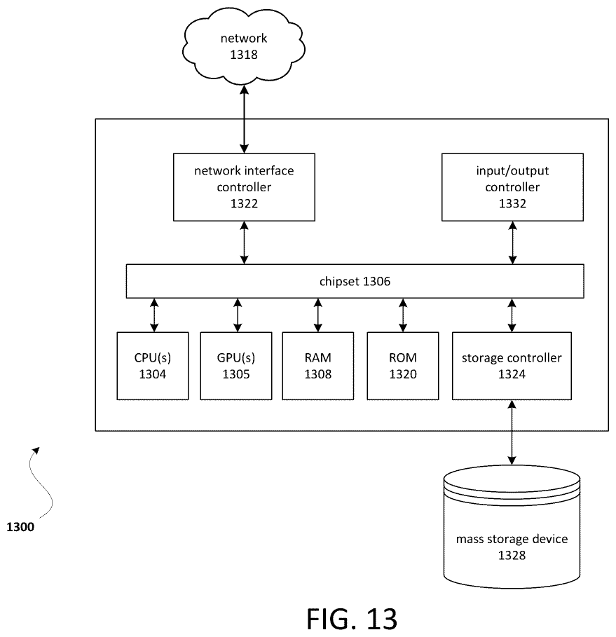

FIG. 13 illustrates a computing device that may be used in various aspects, such as the services, networks, modules, and/or devices depicted in FIG. 1. With regard to the example architecture of FIG. 1, the cloud network (and any of its components), the client devices, and/or the network may each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s) 1305. The GPU(s) 1305 may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random-access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN). The chipset 1306 may include functionality for providing network connectivity through a network interface controller (NIC) 1322, such as a gigabit Ethernet adapter. A NIC 1322 may be capable of connecting the computing device 1300 to other computing nodes over a network 1316. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. The mass storage device 1328 may comprise a management component 1313. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on the mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1328 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described herein.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing dialog-based music recommendations for input videos, comprising:
inputting a video into a machine learning model, wherein the machine learning model comprises a first sub-model and a second sub-model, and the machine learning model is configured to implement the dialog-based music recommendations for the input videos;
identifying at least one music track by the first sub-model based on the input video;
generating a first set of sentences by the second sub-model, the first set of sentences depicting the at least one music track and recommendation reasons in natural languages;
causing to display the first set of sentences on a computing device associated with a user;
in response to receiving input indicating that the user prefers music different from the at least one music track, identifying at least one other music track based on the input video, previously recommended music track, and the input indicative of the user's preference; and
generating a second set of sentences depicting the at least one other music track in natural languages for display on the computing device.

2. The method of claim 1, wherein the machine learning model is trained on conversational music recommendation data, and wherein the conversational music recommendation data is generated by:
calculating a cosine similarity between each of a plurality of videos and each of a set of music tracks;
selecting candidate music tracks corresponding to each of the plurality of videos based on cosine similarities between each of the plurality of videos and the set of music tracks;
determining music tags and music metadata of an original music track associated with each of the plurality of videos and the candidate music tracks corresponding to each of the plurality of videos; and
generating simulated music recommendation conversations based on the music tags and the music metadata using a generative pre-training transformer (GPT).

3. The method of claim 2, wherein each of the simulated music recommendation conversation begins with recommending one of the candidate music tracks with associated reasons, and then recommends the original music track with reasonings based on recognizing musical differences between the one of the candidate music tracks and the original music track and in response to a simulated input indicating a preference for the original music track.

4. The method of claim 2, further comprising:
generating simulated music recommendation training data in which each sample contains information indicating a video, an original music track associated with the video, at least one candidate music track corresponding to the video, and simulated conversation text.

5. The method of claim 1, wherein the first sub-model is trained to pair at least one music track from a music pool to fit an overall video, and wherein the first sub-model is trained to alter music recommendation from a previously recommended music track to a currently recommended music track.

6. The method of claim 1, wherein the first sub-model comprises a trainable linear projection layer to project video modality, music modality, and text modality into a same embedding space.

7. The method of claim 1, wherein the first sub-model is trained on video data, music data, and text data comprising simulated music recommendation conversation text.

8. The method of claim 1, wherein the second sub-model is trained to express music recommendations and recommendation reasons in natural languages.

9. The method of claim 1, wherein the second sub-model comprises trainable linear projection layers, and wherein the second sub-model is trained on data each instance of which comprises a music representation from the first sub-model and corresponding recommendation reasoning statements from simulated conversational music recommendation dataset.

10. A system, comprising:
at least one processor; and
at least one memory comprising computer-readable instructions that upon execution by the at least one processor cause the system to perform operations comprising:
inputting a video into a machine learning model, wherein the machine learning model comprises a first sub-model and a second sub-model, and the machine learning model is configured to implement the dialog-based music recommendations for the input videos;
identifying at least one music track by the first sub-model based on the input video;
generating a first set of sentences by the second sub-model, the first set of sentences depicting the at least one music track and recommendation reasons in natural languages;
causing to display the first set of sentences on a computing device associated with a user;
in response to receiving input indicating that the user prefers music different from the at least one music track, identifying at least one other music track based on the input video, previously recommended music track, and the input indicative of the user's preference; and
generating a second set of sentences depicting the at least one other music track in natural languages for display on the computing device.

11. The system of claim 10, wherein the machine learning model is trained on conversational music recommendation data, and wherein the conversational music recommendation data is generated by:
calculating a cosine similarity between each of a plurality of videos and each of a set of music tracks;
selecting candidate music tracks corresponding to each of the plurality of videos based on cosine similarities between each of the plurality of videos and the set of music tracks;
determining music tags and music metadata of an original music track associated with each of the plurality of videos and the candidate music tracks corresponding to each of the plurality of videos; and
generating simulated music recommendation conversations based on the music tags and the music metadata using a generative pre-training transformer (GPT).

12. The system of claim 11, wherein each of the simulated music recommendation conversation begins with recommending one of the candidate music tracks with associated reasons, and then recommends the original music track with reasonings based on recognizing musical differences between the one of the candidate music tracks and the original music track and in response to a simulated input indicating a preference for the original music track.

13. The system of claim 11, the operations further comprising:
generating simulated music recommendation training data in which each sample contains information indicating a video, an original music track associated with the video, at least one candidate music track corresponding to the video, and simulated conversation text.

14. The system of claim 10, wherein the first sub-model is trained to pair at least one music track from a music pool to fit an overall video, and wherein the first sub-model is trained to alter music recommendation from a previously recommended music track to a currently recommended music track.

15. The system of claim 10, wherein the second sub-model is trained to express music recommendations and recommendation reasons in natural languages.

16. A non-transitory computer-readable storage medium, storing computer-readable instructions that upon execution by a processor cause the processor to implement operations, the operation comprising:
inputting a video into a machine learning model, wherein the machine learning model comprises a first sub-model and a second sub-model, and the machine learning model is configured to implement the dialog-based music recommendations for the input videos;
identifying at least one music track by the first sub-model based on the input video;
generating a first set of sentences by the second sub-model, the first set of sentences depicting the at least one music track and recommendation reasons in natural languages;
causing to display the first set of sentences on a computing device associated with a user;
in response to receiving input indicating that the user prefers music different from the at least one music track, identifying at least one other music track based on the input video, previously recommended music track, and the input indicative of the user's preference; and
generating a second set of sentences depicting the at least one other music track in natural languages for display on the computing device.

17. The non-transitory computer-readable storage medium of claim 16, wherein the machine learning model is trained on conversational music recommendation data, and wherein the conversational music recommendation data is generated by:
calculating a cosine similarity between each of a plurality of videos and each of a set of music tracks;
selecting candidate music tracks corresponding to each of the plurality of videos based on cosine similarities between each of the plurality of videos and the set of music tracks;
determining music tags and music metadata of an original music track associated with each of the plurality of videos and the candidate music tracks corresponding to each of the plurality of videos; and
generating simulated music recommendation conversations based on the music tags and the music metadata using a generative pre-training transformer (GPT).

18. The non-transitory computer-readable storage medium of claim 17, wherein each of the simulated music recommendation conversation begins with recommending one of the candidate music tracks with associated reasons, and then recommends the original music track with reasonings based on recognizing musical differences between the one of the candidate music tracks and the original music track and in response to a simulated input indicating a preference for the original music track.

19. The non-transitory computer-readable storage medium of claim 16, wherein the first sub-model is trained to pair at least one music track from a music pool to fit an overall video, and wherein the first sub-model is trained to alter music recommendation from a previously recommended music track to a currently recommended music track.

20. The non-transitory computer-readable storage medium of claim 16, wherein the second sub-model is trained to express music recommendations and recommendation reasons in natural languages.
